(19) United States
(12) Patent Application Publication
(10) Pub. No.: US 2020/0208550 A1
(43) Pub. Date: Jul. 2, 2020

(54) REINFORCED STRUCTURAL BODY AND METHOD OF MANUFACTURING REINFORCED STRUCTURAL BODY

(71) Applicants: MAHLE International GmbH, Stuttgart (DE); MAHLE Filter Systems Japan Corporation, Tokyo (JP)

(72) Inventors: Atsushi Nonaka, Tokyo (JP); Shintaro Ishigami, Tokyo (JP)

(21) Appl. No.: 16/729,392

(22) Filed: Dec. 28, 2019

(30) Foreign Application Priority Data
Dec. 28, 2018 (JP) 2018-245337

(51) Int. Cl. F01M 11/00; F16B 5/02

(52) U.S. Cl. CPC F01M 11/0004; F01M 2011/0087; F01M 2011/0091; F16B 5/0258

(57) ABSTRACT

Provided are a reinforced structural body where an internal tension can be sufficiently generated in a reinforcing member against a deformation input to a body member thus allowing the reinforcing member to properly exhibit a reinforcing effect, and a method of manufacturing the reinforced structural body. An oil pan includes a body member made of a resin which has a plurality of fixing portions to be fixed to a counterpart member which is a fixing object, a reinforcing member which is integrally formed with the body member and has higher rigidity than the body member, and a plurality of bushings which have a higher yield stress than the body member and are fixed to the plurality of fixing portions respectively, wherein the reinforcing member extends between the plurality of bushings so as to connect the plurality of bushings.

### CROSS REFERENCE TO RELATED APPLICATIONS

This application claims priority to Japanese patent application JP 2018-245337, filed Dec. 28,2018, the entire content of which is incorporated herein by reference.

### TECHNICAL FIELD

The present disclosure relates to a reinforced structural body and a method of manufacturing the reinforced structural body, and more particularly to a reinforced structural body including a body member made of a resin and a method of manufacturing the reinforced structural body.

### BACKGROUND

Recently, along with the increase of a demand for the reduction of weight and the reduction of cost in manufacturing a structural body, shifting from a structural body made of a metal to a structural body made of a resin has been steadily underway. As one example, a resin-made oil pan which is a structural body formed by using a resin as a material was proposed (see, e.g., JP 2018-71498). The resin-made oil pan includes an oil pan body portion having a pot shape and a reinforcing portion formed on at least a part of the oil pan body portion. In such a resin-made oil pan, at least one layer of a unidirectional continuous fiber reinforced sheet impregnated with a thermoplastic resin is laminated to at least one of an inner surface and an outer surface of the reinforcing portion. With the provision of the unidirectional continuous fiber reinforced sheet, the resin-made oil pan can increase impact absorbing ability.

However, also with respect to a structural body made of a resin, the number of cases where a large bending stress or a large torsional stress is applied to the structural body is steadily increased. Further, also with respect to a structural body made of a resin, cases where the structural body plays a role as a strength member are increasingly requested. Accordingly, a further improvement of a reinforcing effect of the structural body made of a resin is requested.

### SUMMARY

It is an object of the present disclosure to provide a reinforced structural body where an internal tension can be sufficiently generated in a reinforcing member against a deformation input to a body member thus allowing the reinforcing member to properly exhibit a reinforcing effect, and a method of manufacturing the reinforced structural body.

A reinforced structural body according to an aspect of the disclosure includes a body member made of a resin which has a plurality of fixing portions to be fixed to a counterpart member which is a fixing object, a reinforcing member which is integrally formed with the body member and has higher rigidity than the body member, and a plurality of bushings which have a higher yield stress than the body member and are fixed to the plurality of fixing portions respectively, wherein the reinforced structural body is configured such that, in fixing the body member to the counterpart member, a plurality of fasteners are inserted into the plurality of bushings respectively and are fastened to the counterpart member so that the plurality of bushings are fixed to the counterpart member, and the body member is fixed to the counterpart member by the plurality of bushings, and the reinforcing member extends between the plurality of bushings so as to connect the plurality of bushings.

In fixing the body member to the counterpart member, the body member is fixed to the counterpart member by the plurality of fasteners which are inserted into the plurality of bushings fixed to the fixing portions, and the reinforcing member having higher rigidity than the body member extends between the plurality of bushings having a higher yield stress than the body member so as to connect the plurality of bushings. Accordingly, when a deformation input such as vibration or a load is generated in the reinforced structural body, the reinforcing member which extends between the plurality of bushings is pulled by a deformation input and hence, an internal tension is generated in the reinforcing member whereby the deformation of the reinforced structural body can be prevented. As a result, in the reinforced structural body, an internal tension can be sufficiently generated in the reinforcing member against a deformation input to the body member and hence, the reinforcing member can properly exhibit a reinforcing effect.

In the reinforced structural body according to an aspect of the disclosure, the reinforcing member may wrap around at least a part of an outer periphery of each of the plurality of bushings in an axial direction. When a deformation input is generated in the reinforced structural body, the reinforcing member which wraps around at least the part of the plurality of bushings is pulled and hence, an internal tension generated in the reinforcing member is increased thus capable of preventing the deformation of the reinforced structural body. Accordingly, in the reinforced structural body, the reinforcing member can more properly exhibit a reinforcing effect.

In the reinforced structural body according to an aspect of the disclosure, the reinforcing member may include a wire-like material. When a deformation input is generated in the reinforced structural body, an internal tension is generated in the reinforcing member along the wire-like material and hence, the deformation of the reinforced structural body can be prevented more effectively. Accordingly, in the reinforced structural body, the reinforcing member can more properly exhibit a reinforcing effect.

In the reinforced structural body according to an aspect of the disclosure, each of the plurality of bushings may have higher rigidity than the reinforcing member. With such an aspect, when a deformation input is generated in the reinforced structural body, the deformation of the bushing can be prevented more effectively and hence, an internal tension is generated in the reinforcing member more efficiently and hence, the deformation of the reinforced structural body can be prevented more effectively. Accordingly, in the reinforced structural body, the reinforcing member can more properly exhibit a reinforcing effect.

In the reinforced structural body according to an aspect of the disclosure, the reinforcing member may be disposed on a surface of the body member. The deformation of the reinforced structural body can be prevented by the reinforcing member formed on a surface side of the body member and hence, the reinforcing member can be easily disposed on the body member.

In the reinforced structural body according to an aspect of the disclosure, the reinforcing member may be disposed in the body member. The deformation of the reinforced structural body can be prevented by the reinforcing member disposed on the surface side of the body member; the deterioration of the reinforcing member attributed to an external environment can be prevented.

In the reinforced structural body according to an aspect of the disclosure, the reinforced structural body may be an oil pan. There is a concern that deformation such as bending or twisting caused by vibration from a transmission is excessively largely inputted to a fastening part between the oil pan and the transmission. In the reinforced structural body, it is possible to sufficiently generate an internal tension in the reinforcing member against a deformation input to the oil pan and hence, the reinforcing member can properly exhibit a reinforcing effect of reinforcing the oil pan.

A method of manufacturing a reinforced structural body according to an aspect of the disclosure is a method of manufacturing a reinforced structural body having a body member made of a resin and a reinforcing member integrally formed with the body member, the method including a first step of arranging a plurality of bushings at respective portions of a mold for forming the reinforced structural body which correspond to a plurality of fixing portions of the body member to be fixed to a counterpart member which is a fixing object, a second step of arranging a reinforcing member having higher rigidity than the main member between the plurality of bushings so as to connect the plurality of bushings, and a third step of integrally forming the body member with the plurality of bushings and the reinforcing member.

In fixing the manufactured reinforced structural body to the counterpart member, the body member can be fixed to the counterpart member by the plurality of fasteners which are inserted into the plurality of bushings fixed to the fixing portions, and the reinforcing member having higher rigidity than the body member extends between the plurality of bushings having a higher yield stress than the body member so as to connect the plurality of bushings. Accordingly, a deformation input such as vibration or a load is generated in the reinforced structural body, the reinforcing member which extends between the plurality of bushings is pulled by a deformation input and hence, an internal tension is generated in the reinforcing member whereby the deformation of the reinforced structural body can be prevented. As a result, with the method of manufacturing the reinforced structural body, the reinforced structural body can be manufactured where an internal tension can be sufficiently generated in the reinforcing member against a deformation input to the body member thus allowing the reinforcing member to properly exhibit a reinforcing effect.

### Advantageous Effects of Disclosure

According to the present disclosure, it is possible to realize a reinforced structural body where an internal tension can be sufficiently generated in a reinforcing member against a deformation input to a body member thus allowing the reinforcing member to properly exhibit a reinforcing effect, and a method of manufacturing the reinforced structural body.

### BRIEF DESCRIPTION OF THE DRAWINGS

The disclosure will now be described with reference to the drawings wherein:

FIG. 1 is an explanatory view of a connection relationship between an engine having an oil pan which forms a reinforced structural body and a transmission according to an exemplary embodiment of the disclosure;

FIG. 2 is an exploded perspective view schematically showing the oil pan according to an exemplary embodiment of the disclosure;

FIG. 3 is a perspective view schematically showing the oil pan according to an exemplary embodiment of the disclosure;

FIG. 4 is a view of a reinforcing member according to an exemplary embodiment of the disclosure;

FIG. 5 is a view showing a state where the oil pan according to the embodiment of the present disclosure is fixed to an engine and a transmission;

FIG. 6 is a partially enlarged view of FIG. 5;

FIG. 7 is a view showing the structure of a conventional oil pan;

FIG. 8 is a view showing the structure of the conventional oil pan;

FIG. 9 is a view showing another example of the oil pan according to an exemplary embodiment of the disclosure;

FIG. 10 is a flowchart showing a method of manufacturing the oil pan according to an exemplary embodiment of the disclosure; and

FIG. 11 is a schematic view of a suspension arm to which the reinforced structural body is applied according to an exemplary embodiment of the disclosure.

### DESCRIPTION OF EXEMPLARY EMBODIMENTS

Hereinafter, exemplary embodiments of the present disclosure will be described in detail with reference to the accompanying drawings. The present disclosure is not limited to the exemplary embodiments described hereinafter, and can be carried out with suitable changes. Further, the following exemplary embodiments can be carried out in desired combinations.

In the exemplary embodiment described hereinafter, a case where a reinforced structural body is used as an oil pan is exemplified. In an automobile or the like which uses an internal combustion engine such as an engine, an oil pan which is a container for storing oil circulating in the engine is attached to a lower portion of the engine. Such an oil pan is, in general, fastened to a lower surface of an engine block, and also to a transmission disposed at a rear side of the engine. As a structural body, the oil pan also has a function of suppressing vibration between the engine and the transmission. Such an oil pan is, in general, formed using metal such as aluminum having high strength and high rigidity. On the other hand, recently, from a viewpoint of reducing a weight of an automobile or the like, a technique for forming an oil pan using a resin has been studied. In the oil pan made of a resin, deformation such as bending or twisting generated by vibration from the transmission is excessively inputted to a fastening part of the oil pan with the transmission. Accordingly, cases exist where the oil pan cannot properly exhibit a sufficient reinforcing effect.

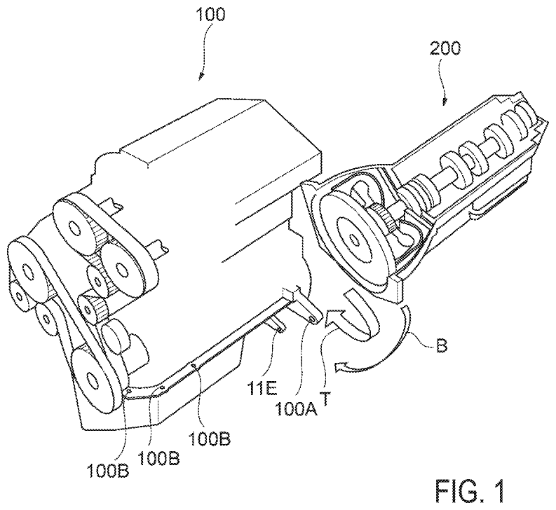

FIG. 1 is a schematic view of a connection relationship between an engine having an oil pan which forms a reinforced structural body and a transmission. In FIG. 1, the oil pan 1, the engine 100, and the transmission 200 are schematically shown.

As shown in FIG. 1, the oil pan 1 is attached to a lower portion of the engine 100. The transmission 200 is disposed on a rear portion of the engine 100. The transmission 200 is fixed by fastening to the engine 100 by way of fastening portions 100A. The oil pan 1 is fixed by fastening to the engine 100 by way of a plurality of fastening portions 1A, at the same time, the oil pan 1 is also fixed to the oil pan by way of fastening portions 1B. With respect to the oil pan 1, the engine 100, and the transmission 200 connected to each other as described above, the oil pan 1 performs, as a structural body, a function of suppressing vibration generated between the engine 100 and the transmission 200. Accordingly, deformation such as bending B or twisting T generated based on vibration from the transmission 200 is excessively inputted particularly to the fastening portions 1B on a transmission 200 side of the oil pan 1.

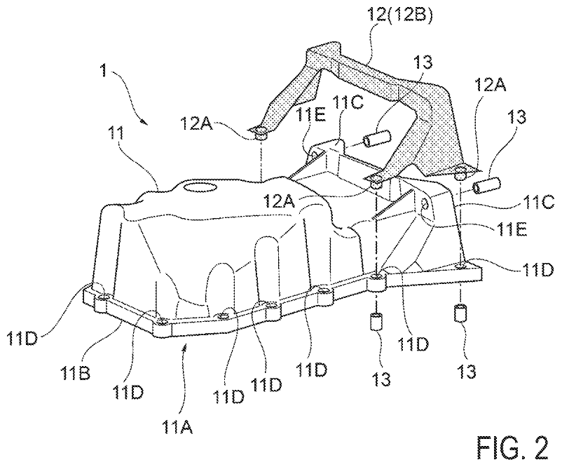

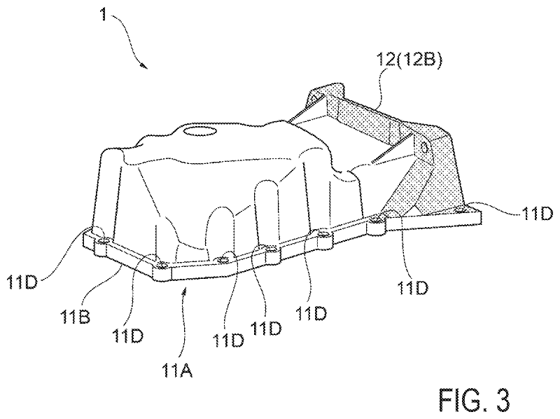

FIG. 2 is an exploded perspective view schematically showing the oil pan according to an exemplary embodiment of the disclosure. FIG. 3 is a perspective view schematically showing the oil pan according to an exemplary embodiment of the present invention. FIGS. 2 and FIG. 3 are perspective views where the oil pan 1 shown in FIG. 1 is viewed from below.

As shown in FIG. 2, the oil pan 1 has a body member 11 made of a resin and a reinforcing member 12 integrally formed with at least a part of the body member 11 and having higher rigidity than the body member 11. As a resin used for forming the body member 11, for example, a polyamide (PA) resin, a polyimide (PI) resin and the like are utilized. “Higher rigidity” means that a modulus of elasticity such as a Young's modulus or a modulus of rigidity is large.

The body member 11 has an approximately pot shape, and has an oil storing portion 11A formed at a center portion of the body member 11, a connecting portion 11B formed at an outer peripheral portion of the body member 11, and a connecting portion 11C formed at a rear side of the body member 11 which is a transmission 200 (not shown in FIG. 2, see FIG. 1) side. Engine oil is stored in the oil storing portion 11A. The connecting portion 11B is a connecting portion for connecting the oil pan 1 and the engine (counterpart member) 100 which is a fixing object to which the oil pan 1 is fixed. A plurality of fixing portions 11D used for fastening the body member 10 and the engine 100 to each other are formed in the connecting portion 11B. The plurality of fixing portions 11D are, for example, through holes having an approximately circular cylindrical shape. The shape of the each of the plurality of fixing portions 11D is not limited to an approximately circular cylindrical shape and can be suitably changed.

The connecting portion 11C which forms a connecting part for connecting the body member 11 and the transmission 200 is formed at the rear side of the body member 11 which is the transmission (counterpart member) 200 (not shown in FIG. 2, see FIG. 1) side. A plurality of fixing portions 1E are formed in the connecting portion 11C used for fixing the oil pan 1 to the transmission (counterpart member) 200 which is a fixing object to which the oil pan 1 is fixed. The plurality of fixing portions 11E are, for example, through holes having an approximately circular cylindrical shape. Bushings 13 each having an approximately circular cylindrical shape are fixed by press-fitting to the plurality of fixing portions 11E (see FIG. 3). The shape of each of the plurality of fixing portions 11E is not limited to an approximately circular cylindrical shape and can be suitably changed.

The reinforcing member 12 is disposed in a fixed area including the connecting portion 11E of the body member 11 on the transmission 200 side. The reinforcing member 12 has inserting portions 12A which are inserted into a plurality of fixing portions 11D and 11E, and an extending portion 12B which are disposed between the respective inserting portions 12A. The reinforcing member 12 is fixed to the body member 11 by press-fitting bushings 13 respectively having an approximately circular cylindrical shape and having a higher yield stress than the body member 11 into inserting portions 12A inserted into the plurality of fixing portions 11D and 11E. The reinforcing member 12 may be disposed over the entire body member 11. The shape of the bushing 13 is not always limited to an approximately circular cylindrical shape and can be suitably changed. Provided that the bushing 13 has a yield stress equal to or more than a yield stress of the body member 11, various materials having rigidity are applicable for forming the bushing 13 besides metal. The extending portion 12B extends between the inserting portions 12A so as to connect the inserting portions 12A inserted into the respective fixing portions 11D and 11E.

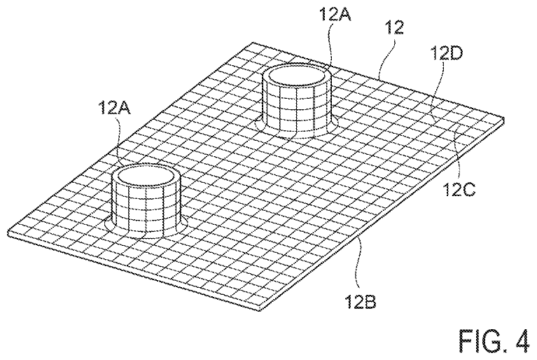

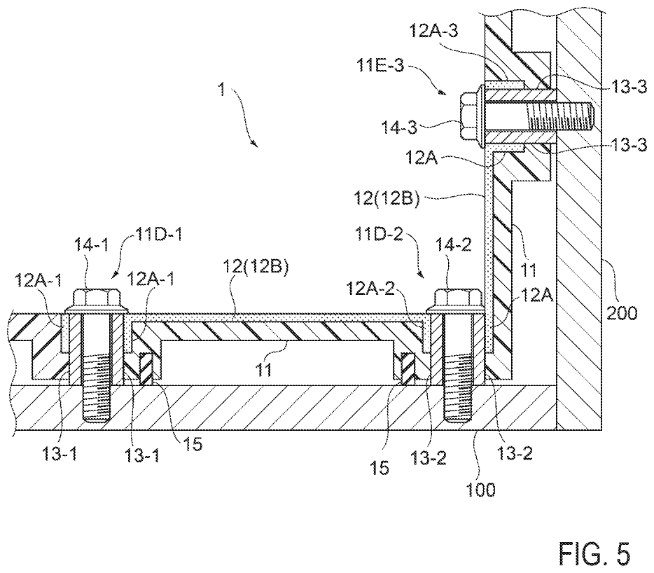

FIG. 4 is an schematic view of the reinforcing member 12 according to an exemplary embodiment of the disclosure. As shown in FIG. 4, the reinforcing member 12 has a sheet like shape, and the inserting portions 12A having an approximately circular cylindrical shape are connected to each other by the extending portion 12B. The inserting portions 12A can be obtained by burring forming, for example. By forming the extending portions 12A in this manner, each inserting portion 12A can wrap around at least a part of an outer periphery of the bushing 13 in an axial direction (see FIG. 5). The shape of the inserting portion 12A is not limited to an approximately circular cylindrical shape, and the shape of the inserting portion 12A is not limited provided that at least a part of the inserting portion 12A can be inserted in the fixing portion 11D, 11E.

In the exemplary embodiment, the extending portion 12B may include longitudinal direction wire-like members 12C extending in a longitudinal direction and lateral direction wire-like members 12D extending in a lateral direction. With such a configuration, when deformation is inputted to the reinforcing member 12, an internal tension is transmitted in a longitudinal direction by way of the longitudinal direction wire-like members 12C, and the internal tension is transmitted in a lateral direction by way of the lateral direction wire-like members 12D. As a result, when deformation is inputted to the oil pan 1, an internal tension is transmitted in the extending portion 12B longitudinally and laterally by way of the longitudinal direction wire-like members 12C and the lateral direction 12D and hence, the oil pan 1 can be reinforced more properly against a deformation input. The wire-like member 12B may be formed of, for example, continuous fibers such as carbon fibers or glass fibers. The extending portion 12B may be formed of a metal-based fiber material such as a metal mesh, for example, besides an organic fiber-based raw material. As the continuous fibers, a unidirectional (UD) tape where wire-like members extend in one direction may be used. From a viewpoint of acquiring the above-mentioned manner of operation and advantageous effects, it is typical to use a woven fabric which includes the longitudinal direction wire-like members 12C and the lateral direction wire-like members 12D which extend longitudinally and laterally.

FIG. 5 is an schematic view showing a state where the oil pan is fixed to the engine and the transmission. In the example shown in FIG. 5, the oil pan 1 is fastened to the engine 100 by fasteners 14-1 inserted in bushings 13-1 disposed in fixing portions 11D-1 of the body member 11, and fasteners 14-2 inserted in bushings 13-2 disposed in fixing portions 11D-2. The fasteners 14-1 and 14-2 are bolts and nuts, for example. With such a configuration, in the oil pan 1, the plurality of bushings 13-1 and 13-2 are fixed to the engine 100, and the body member 11 is fixed to the engine 100 by the plurality of bushings 13-1 and 13-2. As a result, fastening between the oil pan 1 and the engine 100 is not complete semi-float fastening, but is rigid fastening where the oil pan 1 and the engine 100 are fastened to each other using bolts by way of the bushings 13 which are rigid members. Gaskets 15 are disposed between the fixing portion 11D-1 and the fixing portion 11D-2 of the body member 11. The gaskets 15 enhance sealing property between the engine 100 and the body member 11. The gaskets may be formed using rubber as a material, for example.

The oil pan 1 is fastened to the transmission 200 by fasteners 14-3 inserted in bushings 13-3 disposed in the fixing portions 11E-3 of the body member 11. The fasteners 14-3 are, for example, bolts and nuts. With such a configuration, in the oil pan 1, the bushings 13-3 are fixed to the engine 100, and the body member 11 is fixed to the transmission 200 by way of the plurality of bushings 13-3. As a result, the oil pan 1 and the transmission 200 are fastened to each other using the bolts by the bushings 13 which are rigid members and hence, the oil pan 1 is firmly fixed to the transmission 200.

The reinforcing member 12 is disposed on an upper surface of the body member 11. The inserting portion 12A-1 of the reinforcing member 12 is inserted between the bushing 13-1 and the body portion 11 in the fixing portion 11D-1. The inserting portion 12A-1 of the reinforcing member 12 is formed so as to wrap around at least a part of an outer peripheral portion of the bushing 13-1 in an axial direction. An inserting portion 12A-2 of the reinforcing member 12 is inserted between the bushing 13-2 and the body portion 11 in the fixing portion 11D-2. The inserting portion 12A-2 of the reinforcing member 12 is disposed so as to wrap around at least a part of an outer peripheral portion of the bushing 13-2 in an axial direction. An inserting portion 12A-3 of the reinforcing member 12 is inserted between the bushing 13-3 and the body portion 11 in the fixing portion 11E-3. The inserting portion 12A-3 of the reinforcing member 12 is disposed so as to wrap around at least a part of an outer peripheral portion 13-3A of the bushing 13-3 in an axial direction. The extending portion 12B is disposed on a surface of the body member 11 so as to make connection between the inserting portion 12A-1 to the inserting portion 12A-3.

That is, in the exemplary embodiment, the extending portion 12B disposed on the body member 11 makes connection such that three points consisting of the inserting portions 12A-1 to 12A-3 respectively connected to the bushings 13-1 to 13-3 are connected to each other. With such a configuration, even when deformation such as bending or twisting generated based on vibration from the transmission 200 is inputted to the oil pan 1, it is possible to disperse the inputted deformation to the respective fixing portions 12D-1, 12D-2, and 12E-1 by an internal tension of the reinforcing member 12.

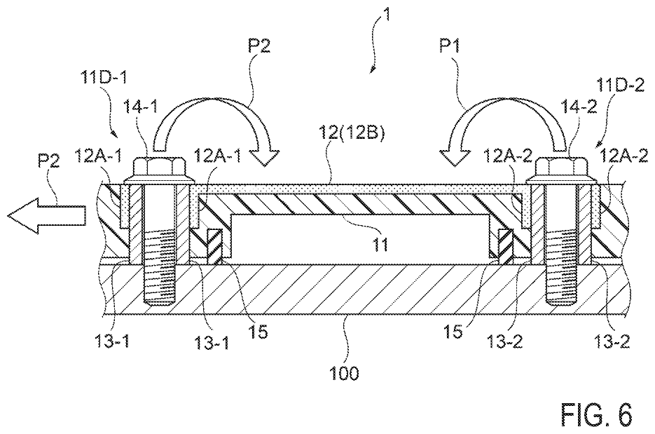

FIG. 6 is a partially enlarged view of FIG. 5. FIG. 6 shows an attaching portion where the oil pan 1 is attached to the engine 100 in FIG. 5.

As shown in FIG. 6, in the oil pan 1, the body member 11 is fixed to the engine 100 by the bushings 13-1 and 13-2 respectively inserted into the fixing portions 11D-1 and 11D-2. Further, in the oil pan 1, the inserting portions 12A-1 and 12A-2 which are connected to the respective bushings 13-1 and 13-2 having a higher yield stress than the body member 11 are connected to each other by the extending portion 12B. Accordingly, the extending portion 12B is pulled by the bushings 13-1 and 13-2 and hence, an internal stress P1 acts in the reinforcing member 12. Particularly, in the exemplary embodiment, the inserting portions 12A-1 and 12A-2 of the reinforcing member 12 respectively wrap around the bushings 13-1 and 13-2 and hence, the internal stress P1 acts more strongly in the reinforcing member 12. Since the internal stress P1 acts in the reinforcing member 12, even when a stress P2 generated based on vibration or a load from the transmission 200 or the like is inputted to the oil pan 1, the movement and deformation of the body member 11 can be prevented and hence, vibration from the transmission 200 can be efficiently prevented.

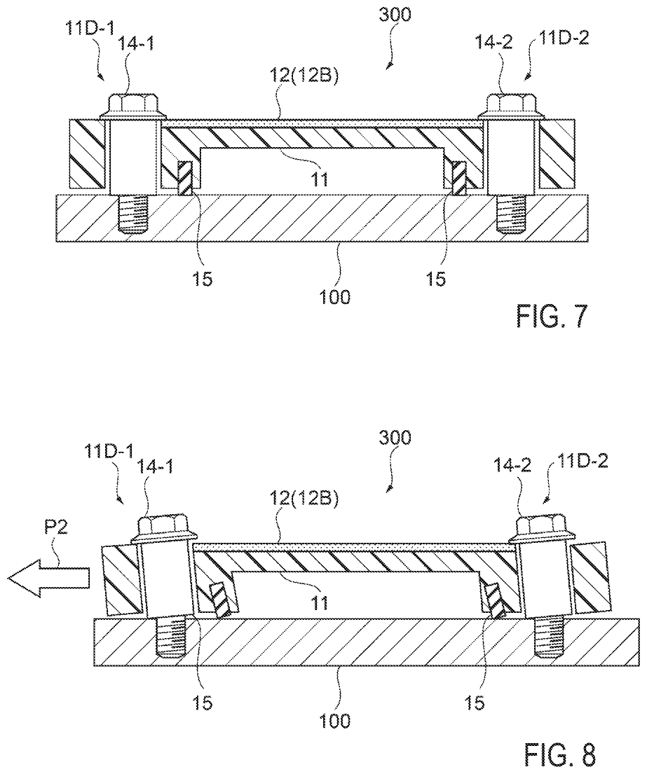

Hereinafter, a conventional oil pan is described as a comparison example of the oil pan 1 according to the above-mentioned exemplary embodiment. FIG. 7 is a view showing the structure of the conventional oil pan 300. In the example shown in FIG. 7, compared to the above-mentioned oil pan 1, the oil pan 300 does not have the bushings 13-1 and 13-2 fixed to the fixing portions 11D-1 and 11D-2, and a reinforcing member 12 does not have the inserting portions 12A-1 and 12A-2 inserted in the fixing portions 11D-1 and 11D-2. Other components are similar to the corresponding components of the oil pan 1 shown in FIG. 5 and hence, the description of these components is omitted.

The oil pan 300 is in a so-called semi-float state where an engine 100 and a body member 11 are fastened to each other by fasteners 14-1 and 14-2 with gaskets 15 made of rubber sandwiched between the engine 100 and the body member 11. Further, in the oil pan 300, deformation of the oil pan 300 is suppressed by providing the reinforcing member 12 which contains continuous fibers such as glass fibers or carbon fibers on a surface of the body member 11. However, as shown in FIG. 8, in the case where the reinforcing member 12 is simply provided on the body member 11 as in the case of the oil pan 300, when a stress P2 generated based on vibration or a load from a transmission 200 or the like is inputted to the oil pan 300, the body member 11 itself which forms a foundation portion of fixing portions 11D-1 and 11D-2 is moved and deformed. As a result, in the oil pan 300, a reinforcing effect brought about by the reinforcing member 12 cannot be sufficiently obtained and hence, worsening of vibration of the transmission 200 cannot be sufficiently prevented.

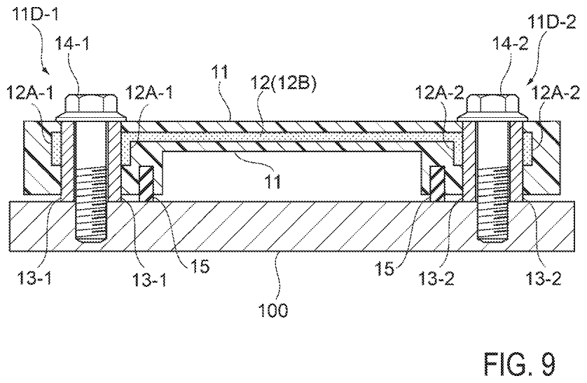

In the above-mentioned embodiment, the example is described where the reinforcing member 12 is provided to one surface of the body member 11. However, the present disclosure is not limited to such a configuration. FIG. 9 is a view showing another exemplary embodiment of the oil pan. As shown in FIG. 9, a reinforcing member 12 is disposed in a body member 11. The reinforcing member 12 is embedded in the body member 11. Even in the case where the reinforcing member 12 is provided in this manner, in a similar manner to the example shown in FIG. 6, an internal stress P1 acts on the reinforcing member 12 and hence, moving and deformation of the body member 11 can be properly prevented.

Next, a method of manufacturing the oil pan 1 according to an exemplary embodiment of the disclosure is described. The method of manufacturing the reinforced structural body according to the exemplary embodiment is a method of manufacturing the oil pan 1 having the body member 11 made of a resin and the reinforcing member 12 integrally formed with the body member.

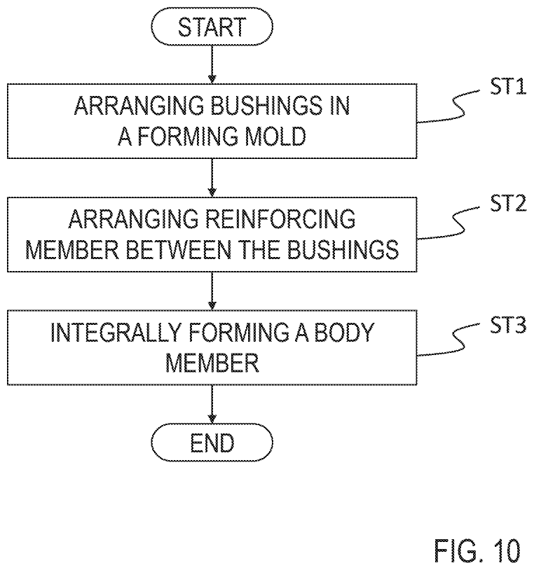

FIG. 10 is a flowchart schematically showing the method of manufacturing the oil pan according to an exemplary embodiment of the disclosure. As shown in FIG. 10, the method of manufacturing the oil pan 1 includes a first step ST1 where the plurality of bushings 13 are arranged at respective portions of a mold for forming the oil pan 1 corresponding to the plurality of fixing portions 11D and 11E used for fixing the body member 11 to the engine 100 and the transmission 200 which are fixing objects; and second step ST2 where the reinforcing member 12 having higher rigidity than the body member 11 is arranged between the plurality of bushings 13 so as to connect the plurality of bushings 13, and third step ST3 where the body member 11 is integrally formed with the plurality of bushings 13 and the reinforcing member 12.

In first step ST1, a forming mold of the oil pan 1 is prepared, and the plurality of bushings 13 are arranged at the respective portions of the prepared forming mold corresponding to the plurality of fixing portions 11D and 11E used for fixing the body member 11 to the engine 100 and the transmission 200. With such a step, the plurality of bushings 13 are preliminarily arranged respectively at the plurality of fixing portions 11D and 11E of the body member 11 to be fixed to the engine 100 and the transmission 200.

In the second step ST2, the reinforcing member 12 having higher rigidity than the body member 11 is arranged between the plurality of bushings 13 so as to connect the plurality of bushings 13. In this step, as the reinforcing member 12, a reinforcing member having inserting portions 12A each of which is formed so as to wrap around at least a part of each of the plurality of bushings 13 in an axial direction may be used. With such an operation, it is possible to maintain a state where the reinforcing member 12 connects the plurality of bushings 13 to each other even after the body member 11 is integrally formed in third step ST3 described later.

In third step ST3, the body member 11 is integrally formed with the plurality of bushings 13 and the reinforcing member 12 disposed on the forming mold. The forming method at the time of performing integral molding is not particularly limited provided that the body member 11 is formed. For example, it is possible to use an injection over molding method where a resin for forming the body member is injected into a forming mold for forming the oil pan 1 in which the reinforcing member 12 is disposed. With the use of such a method, whichever shape the reinforcing member 12 used in the method of manufacturing the oil pan 1 has, it is possible to perform integral forming by filling a resin for forming the body member 11 in the forming mold such that the reinforcing member conforms with the forming mold. Accordingly, it is possible to obtain the oil pan 1 shown in FIG. 3 where the plurality of bushings 13 are preliminarily fixed in the plurality of fixing portions 11D and 11E and the plurality of bushings 13 are connected to each other by the reinforcing member 12.

As has been described heretofore, according to the above-mentioned exemplary embodiment, in fixing the body member 11 to the engine 100, the body member 11 is fixed to the engine 100 by way of the plurality of fasteners 14 which are inserted into the plurality of bushings 13 fixed to the fixing portions 11D, and the reinforcing member 12 having higher rigidity than the body member 11 extends between the bushings 13 having a higher yield stress than the body member 11 so as to connect the bushings 13. Accordingly, when a deformation input P2 such as vibration or a load is generated in the oil pan 1, the reinforcing member 12 which extends between the plurality of bushings 13 is pulled by the deformation input P2 and hence, an internal tension P1 is generated in the reinforcing member 12 whereby the deformation of the oil pan 1 can be prevented. As a result, in the oil pan 1, an internal tension P1 can be sufficiently generated in the reinforcing member 12 against a deformation input to the body member 11 and hence, the reinforcing member 12 can properly exhibit a reinforcing effect.

In the above-mentioned exemplary embodiment, the example is described where the inserting portion 12A of the reinforcing member 12 wraps around at least a part of the outer periphery of each bushing 13 in the axial direction. However, the present disclosure is not limited to such a configuration. It is sufficient that the reinforcing member 12 extends so as to connect the respective bushings 13.

Further, in the above-mentioned exemplary embodiment, the bushing 13 may have higher rigidity than the reinforcing member 12. With such a configuration, it is possible to more effectively prevent deformation of the bushing 13 when a deformation input P2 is generated in the oil pan 1. Accordingly, an internal tension is generated in the reinforcing member 12 more efficiently and hence, the deformation of the reinforced structural body can be prevented more effectively.

Further, in the above-mentioned exemplary embodiment, the example is described where the reinforced structural body is applied to the oil pan 1. However, the reinforced structural body is also applicable to fields other than the oil pan 1. The reinforced structural body is also applicable to, for example, a suspension arm 20 of an automobile or the like as shown in FIG. 10.

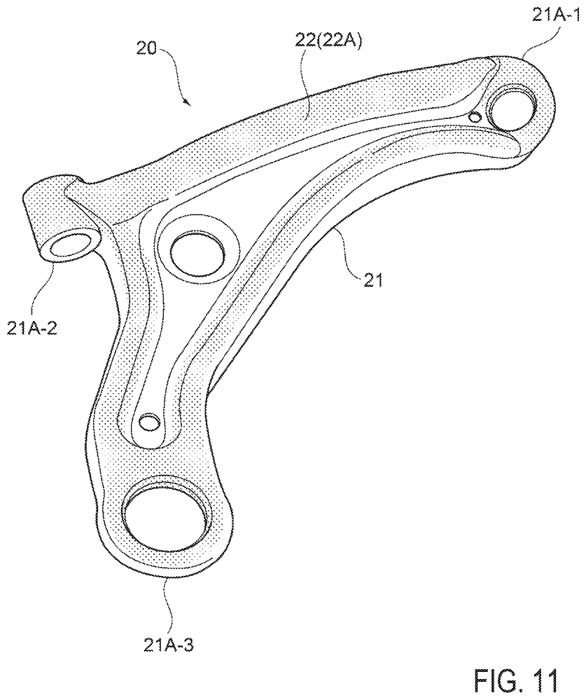

FIG. 11 is a schematic view of a suspension arm to which a reinforced structural body according to the exemplary embodiment is applied. As shown in FIG. 11, the suspension arm 20 includes a body member 21 made of a resin, and a reinforcing member 22 integrally formed on the body member 21. The body member 21 has three fixing portions 21A-1 to 21A-3 which are to be fixed to other members which are fixing objects. In the reinforcing member 22, extending portions 22A extend so as to connect three fixing portions 21A-1 to 21A-3. Other configurations of the reinforcing member 22 of the body portion 21 are equal to the reinforcing member 12 of the above-mentioned oil pan 1. Also, in such a suspension arm 20, bushings (not shown in the drawing) (made of metal, for example) having a higher yield stress than the body member 21 are provided in the fixing portions 21A-1 to 21A-3 respectively. Further, the reinforcing member 22 extends between the respective bushings so as to connect the respective bushings. With such a configuration, in a similar manner to the above-mentioned oil pan 1, it is possible to sufficiently generate an internal tension in the reinforcing member 22 against a deformation input to the body member 21. Accordingly, it is possible to realize the suspension arm where the reinforcing member 22 can properly exhibit a reinforcing effect.

It is understood that the foregoing description is that of the exemplary embodiments of the invention and that various changes and modifications may be made thereto without departing from the spirit and scope of the invention as defined in the appended claims.

What is claimed is:

1. A reinforced structural body comprising:
a body member made of a resin and having a plurality of fixing portions to be fixed to a counterpart member which is a fixing object;
a reinforcing member integrally formed with the body member and having higher rigidity than the body member; and
a plurality of bushings having a higher yield stress than the body member and fixed to the plurality of fixing portions respectively,
wherein the reinforced structural body is configured such that, in fixing the body member to the counterpart member, a plurality of fasteners are inserted into the plurality of bushings respectively and are fastened to the counterpart member so that the plurality of bushings are fixed to the counterpart member, and the body member is fixed to the counterpart member by way of the plurality of bushings, and
wherein the reinforcing member extends between the plurality of bushings so as to connect the plurality of bushings.

2. The reinforced structural body according to claim 1, wherein the reinforcing member wraps around at least a part of an outer periphery of each of the plurality of bushings in an axial direction.

3. The reinforced structural body according to claim 1, wherein the reinforcing member includes a wire-like material.

4. The reinforced structural body according to claim 1, wherein each of the plurality of bushings have higher rigidity than the reinforcing member.

5. The reinforced structural body according to claim 1, wherein the reinforcing member is disposed on a surface of the body member.

6. The reinforced structural body according to claim 1, wherein the reinforcing member is disposed in the body member.

7. The reinforced structural body according to claim 1, wherein the reinforced structural body is an oil pan.

8. A method of manufacturing a reinforced structural body having a body member made of a resin and a reinforcing member integrally formed with the body member, the method comprising:
arranging a plurality of bushings at respective portions of a mold for forming the reinforced structural body which correspond to a plurality of fixing portions of the body member to be fixed to a counterpart member which is a fixing object;
arranging a reinforcing member having higher rigidity than the main member between the plurality of bushings so as to connect the plurality of bushings; and
integrally forming the body member with the plurality of bushings and the reinforcing member.
